(19) United States
(12) Patent Application Publication
(10) Pub. No.: US 2020/0104735 A1
(43) Pub. Date: Apr. 2, 2020

(54) SYSTEMS AND METHODS FOR FUZZY SYMBOL MAPPING AND ARCHITECTURE

(71) Applicant: Nasdaq Technology AB, Stockholm (SE)

(72) Inventor: Sepehr IRANDOOST, New York, NY (US)

(21) Appl. No.: 16/585,323

(22) Filed: Sep. 27, 2019

Related U.S. Application Data
(60) Provisional application No. 62/740,226, filed on Oct. 2, 2018.

(51) Int. Cl. G06N 5/04; G06Q 40/06; G06F 16/18; G06F 16/17

(52) U.S. Cl. CPC G06N 5/048; G06F 16/1734; G06F 16/1865; G06Q 40/06

(57) ABSTRACT

The technology relates to a data communication system that processes data messages in a manner that improves the data communication between devices as well as the ability to provide surveillance over information contained within the data messages. In particular, the technology described herein relates to a system that extracts one or more elements from a data message and applies fuzzy mapping logic to the elements in order to generate a data element representing a symbol where the data elements are then stored and maintained in a database of the system.

### CROSS REFERENCE TO RELATED APPLICATIONS

This application claims priority to U.S. Patent Application No. 62/740,226 filed on Oct. 2, 2018, the entire contents of which are hereby incorporated by reference for all purposes.

### TECHNICAL OVERVIEW

The technology described herein relates to a data communication system that processes data messages in a manner that improves the data communication between devices as well as the ability to provide surveillance over information contained within the data messages. In particular, the technology described herein relates to a system that extracts one or more elements from a data message and applies fuzzy mapping logic to the elements in order to generate a data element representing a symbol where the data elements are then stored and maintained in a database of the system.

### INTRODUCTION

Technology is available for processing data messages by extracting elements from the data message and storing them in a database of a system. For example, certain systems for conducting transactions (e.g., electronic exchanges) process data messages containing elements related to a trade of one or more tradeable instruments. The systems can extract elements and store them in a database of the system where the stored data can be used to process and/or match orders for executing the order as a trade.

Conventional technology is useful for processing these data messages. However, it will be appreciated that new and improved techniques, systems, and processes are continually sought after.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### SUMMARY

The technology described herein addresses the problems in the conventional technology, in part, by providing a system capable of processing data messages by extracting elements from the data message and applying fuzzy logic using the data elements to identify a symbol. For example, the technology parses elements of a data message and applies certain elements to one or more formulas which results in one or more symbol elements being generated.

The symbol elements can be cross-referenced against certain known symbols in a database in order to find a matching symbol. Once a matching symbol is determined, the symbol can be applied against the original data elements to provide a modified/reformatted data message (or the database containing the elements may be updated). The technology thus allows for efficient data message processing that puts the data elements into a condition where they can be accurately processed by the system and/or used for surveillance over the data.

This Summary is provided to introduce a selection of concepts in a simplified form that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

FIGS. 1A and 1B depict non-limiting example block diagrams of a system;

FIG. 2 depicts a non-limiting example block diagram of different software components comprising the system;

FIG. 3 shows a non-limiting example communication process between different devices;

FIG. 4 shows a non-limiting example data file communicated between devices in the system;

FIGS. 5A-D show non-limiting example flowcharts for processes carried out in the system;

FIGS. 6A-C show non-limiting example diagrams of data structures and/or data files; and

FIG. 7 shows a non-limiting example block diagram of hardware components comprising the system shown, at least, in FIG. 2.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

The technology described herein relates to, among other topics, a system for extracting elements from a data message and applying fuzzy mapping logic to the elements in order to generate a data element representing, at least, a symbol. In one example, electronic exchange systems allow different entities (e.g., brokers, traders) to conduct exchange of various tradeable instruments (e.g., securities). Once a transaction is initiated from a client terminal of a broker, trader or other entity, the entire series of processes including the matching of buyers and sellers, and the completion of the transaction happens entirely electronically. The computer systems and communication networks that implement these electronic exchange systems enable large numbers (e.g., several hundred thousands to millions) of trades to execute during a trading day. Many of these trades are completed almost instantaneously (e.g., a fraction of a second) upon a buy or sell order being input to the exchange system and/or the input bid or offer prices matching the market price.

In one non-limiting example, client terminals of an entity (e.g., brokers, traders) will receive an order to be handled by the entity. For example, an individual may place an order with a broker to buy 5000 shares of a tradeable instrument within a given price range. The broker may submit an order data message for the entire amount to an electronic exchange system. However, in many instances, the broker may divide the order into a collection of smaller orders and then send out individual data messages related to each smaller order. While a broker could submit each individual data message to one exchange, in many instances the data messages for the larger order are submitted to multiple exchanges (or markets).

When an order is received by a particular exchange system, the system may extract data elements from the order and store them in a database for attempting to match the order for completion. The data records associated with the orders may be submitted to an external system for analysis. In one example, the external system may conduct surveillance on the data and/or monitor trading activity. In many cases, the client terminals submitting the orders will transmit the order data to the external systems using, for example, an end-of-day trading file.

The system can extract information from the end-of-day trading files and then use the information to provide reports and generate displays so that the information is conveyed to an end user in a meaningful manner. However, certain information in the trading files is necessary for the system to process the information accurately. For example, the system will need to properly identify a tradeable instrument by the instrument's trade symbol (e.g., stock symbol) as these symbols uniquely identify the instrument on a given exchange. It should be appreciated that the stock symbol may include letters, numbers, symbols, or a combination of all.

With the emergence of new exchanges (or markets) and instrument (e.g., asset) classes, a major challenge exists for finding the correct symbology for each exchange and instrument type. In many cases, each exchange proposes its own symbology for a given instrument class and thus the same instrument could be traded on two or more exchanges with different symbology. This inconsistency in symbology has led to several issues, especially with external systems attempting to make sense of the trade order data provided in the trading files. For example, certain external systems may not be able to correctly conduct pre and post surveillance on trading activity across multiple exchanges, and in some cases order data messages with incorrect symbology may be incorrectly executed as a trade at a given exchange system.

In one non-limiting example, such issues may be very prominent for “buy-side” parties that are trading across multiple markets and assets each day. In certain example embodiments, it has been discovered that between 1% to up to 10% in trade failures occur thus resulting in certain trades not correctly executing. It should be appreciated that some of these issues become more complicated when data is used from client terminals for market surveillance and thus the exchange and/or surveillance system will not receive one standard symbology. As an example, a client terminal may refer to a trading symbol for GOLD as “GOLDZ6” where the symbol used at the exchange may be “GOLD16Z.”

The technology described herein can apply fuzzy logic to data elements of an order data message in order to determine the correct symbol for the order on a given exchange. In one non-limiting example, an order data message may comprise a variety of elements including, but not limited to, an exchange type, an asset type, and one or more elements of underlying information. The technology may apply the elements of underlying information to formulas stored in the system to provide fuzzy mapping logic for determining the correct symbology for a given exchange. Such information can enable the system to correctly identify the symbol that uniquely identifies the instrument on an exchange and thus use the correctly identified data to provide reports and/or generate displays so that the information can be conveyed to an end user (e.g., for conducting surveillance in a meaningful manner).

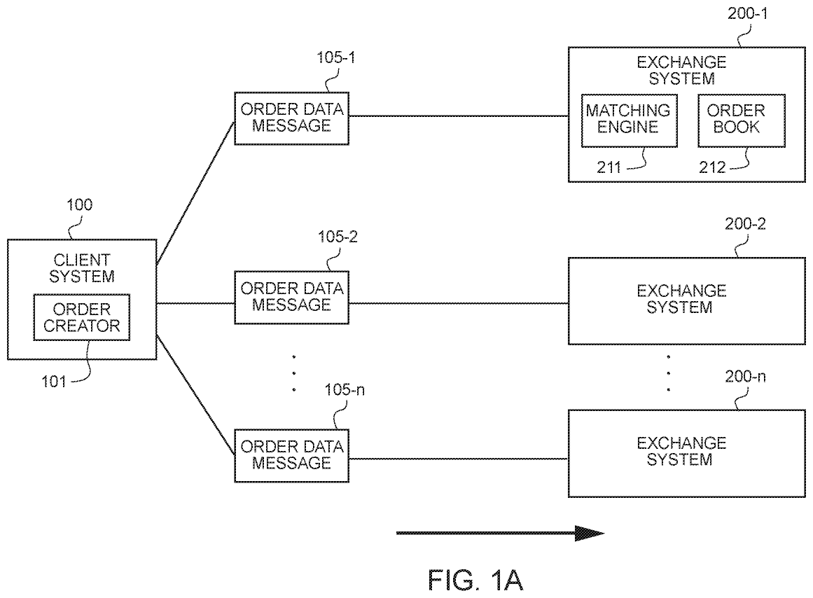

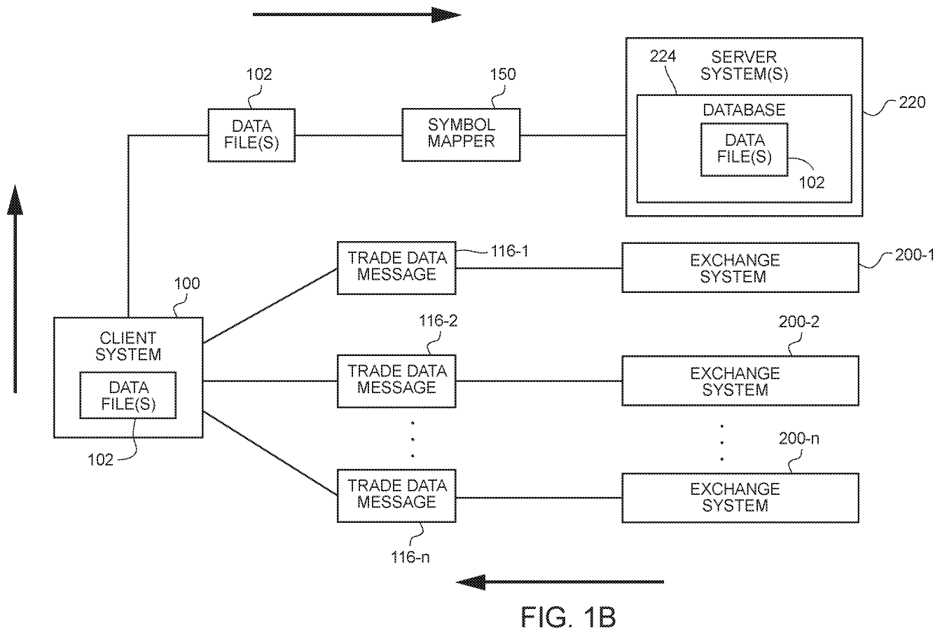

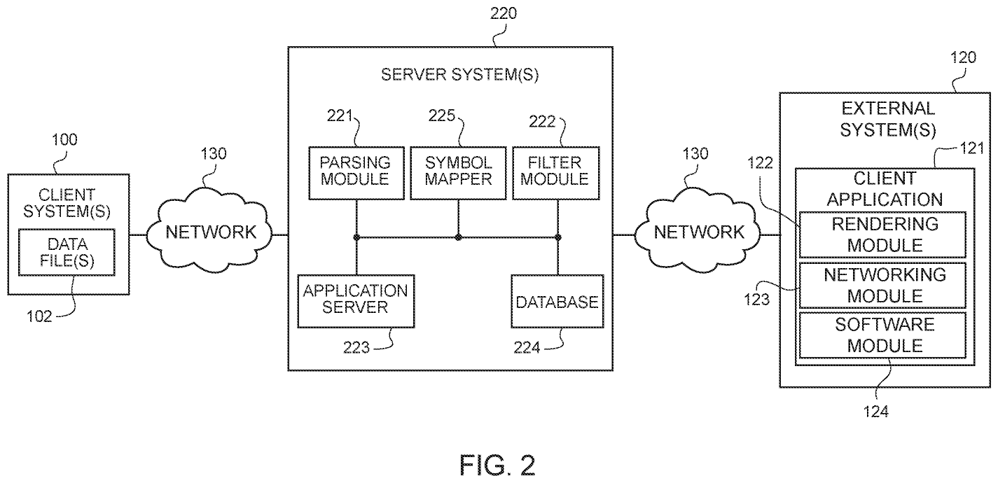

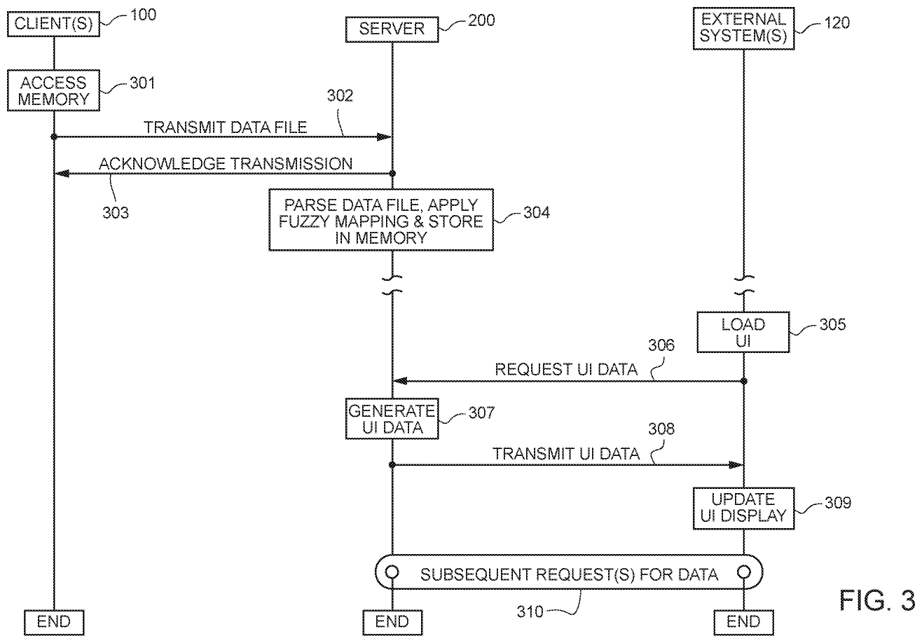

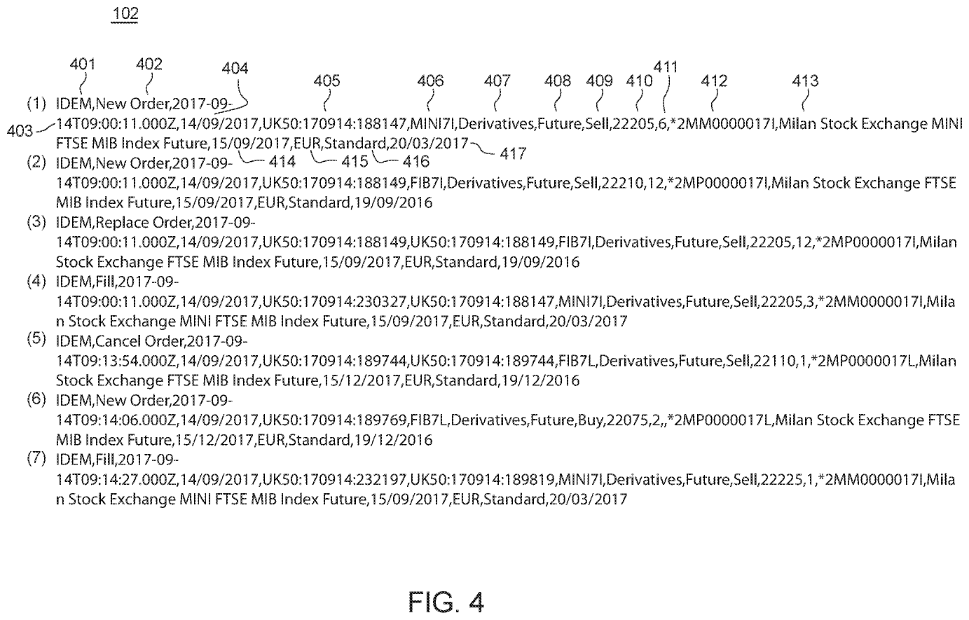

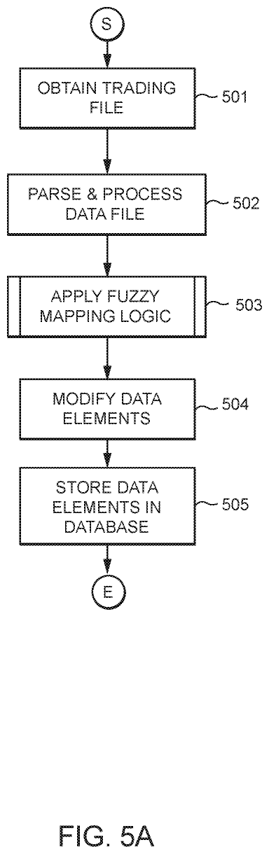

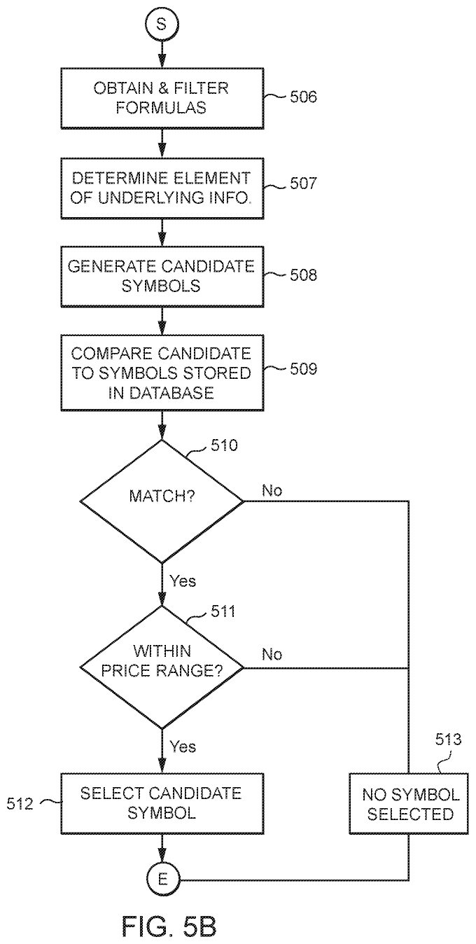

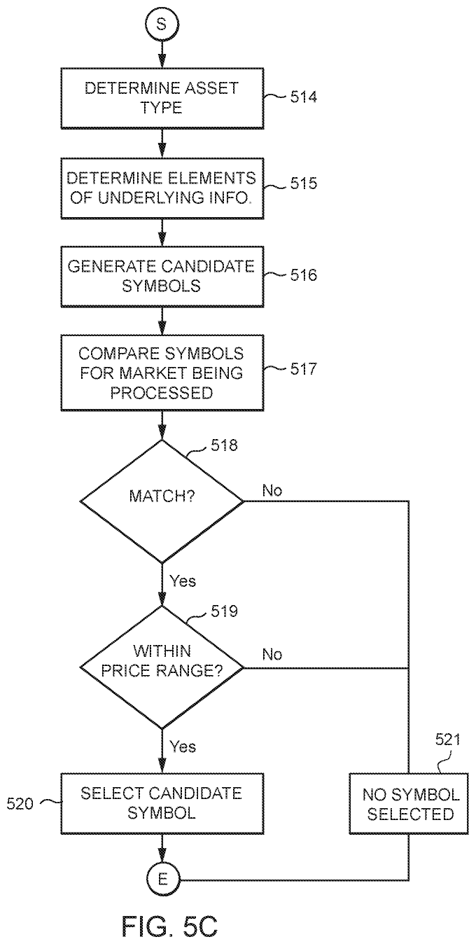

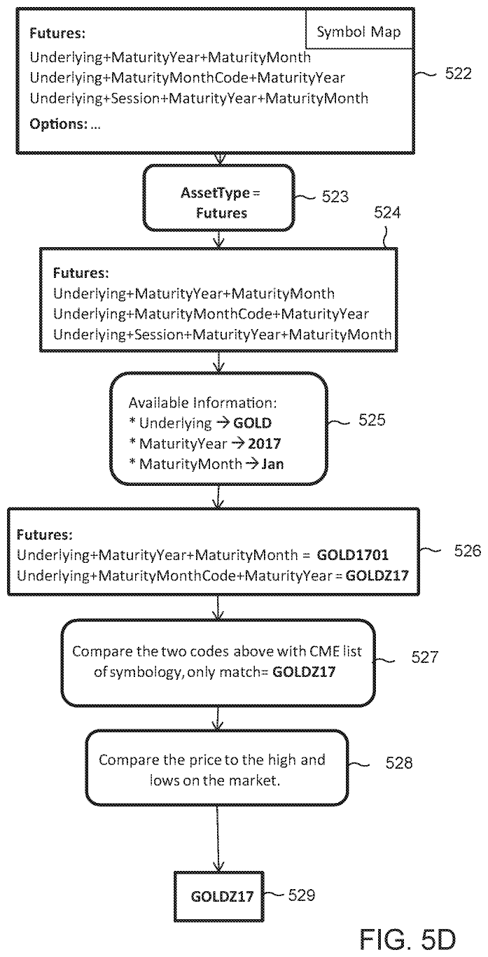

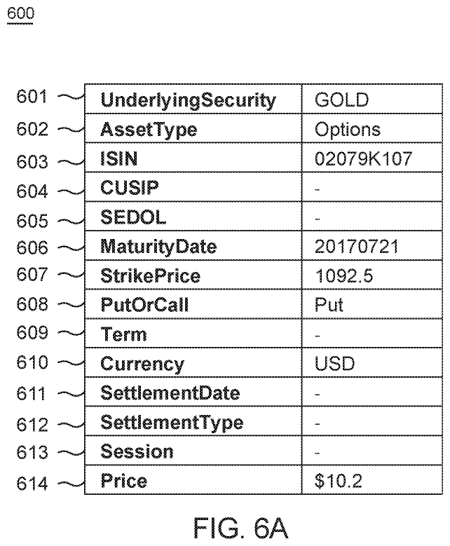

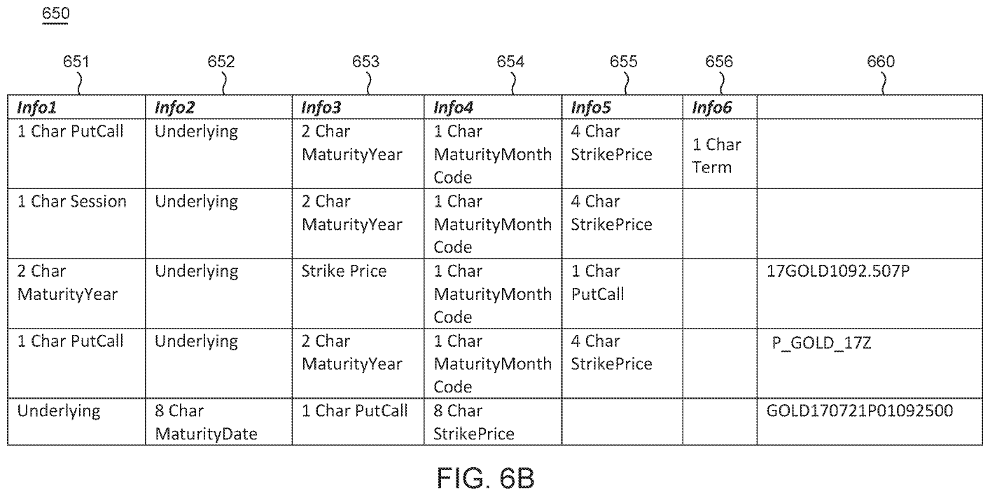

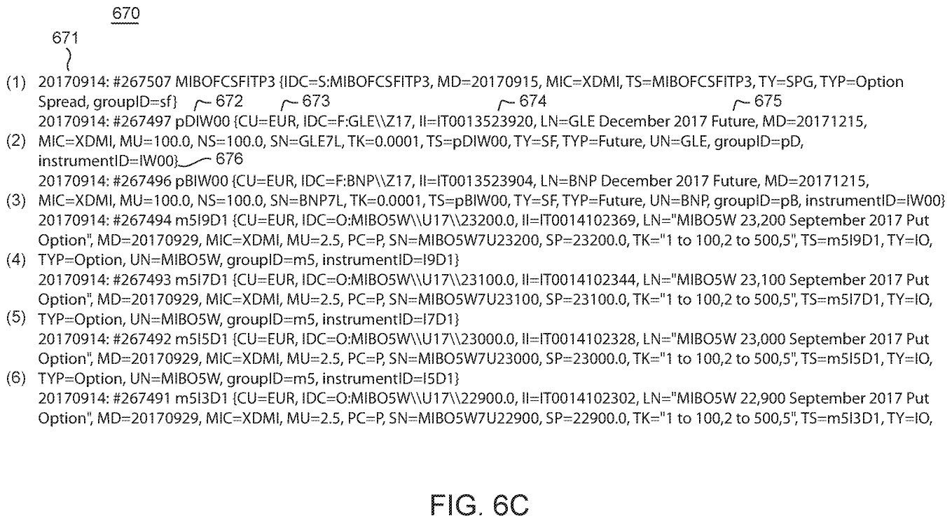

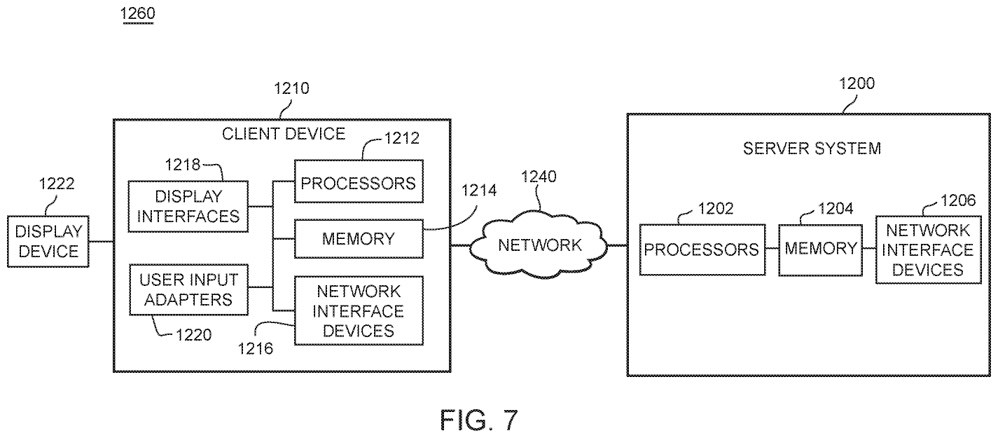

FIGS. 1A and 1B show example systems in which orders are processed (e.g., by an electronic exchange system) and trade data is communicated. FIG. 2 shows different software components comprising the system. FIG. 3 shows a communication process between client system(s), server system(s), and external system(s) for obtaining data related to orders, processing the data, and then generating a user interface. FIG. 4 shows a non-limiting example data file that can be transmitted by a client system and ten processed by a server system. FIGS. 5A-D show example flowcharts for processes carried out in the system in order to process data messages and apply fuzzy mapping logic to elements of the data messages. FIGS. 6A-C show non-limiting example diagrams of data structures and/or data files that are used to determine appropriate symbology for a given exchange. FIG. 7 shows an example system in which the features described herein may be implemented, wherein hardware aspects of the system are highlighted.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

Description of FIGS. 1A and 1B

FIGS. 1A and 1B show non-limiting example system 1 for processing order data. FIG. 1A shows a non-limiting example system where orders can be transmitted from a client system to one or more exchange systems 200-1-200-n. In one non-limiting example, the systems 200-1-200-n can accept order data messages 105-1-105-n from different client devices. Using the example system 200-1, a matching engine 211 can be used to attempt to match the order(s) contained in the order data messages. If a match is found, the order will process (e.g., trade) and the parties associated with the order can receive a confirmation message that the order executed. If no match is found, the order can be stored in an order book 212 memory in the system 200-1 (e.g., for later matching with future orders). It should be appreciated that while system 200-1 is shown containing matching engine 211 and order book 212, all systems 200-1-200-n are configured to contain their own respective matching engine(s) and order book(s).

Although not shown in FIG. 1A, different orders may be communicated between several systems before the order data is received by the systems 200-1-200-n. For example, client system 100 could include multiple client systems 100 (e.g., parent system(s) and child system(s)) that may communicate order messages between each other before the messages are transmitted to the exchange systems 200-1-200-n. An example parent system may include one or more computers operated by an entity such as, for example, a hedge fund that enables entities or individuals to trade various tradeable instruments. As a further example, the hedge fund may create a parent order that is distributed to one or more client (e.g., broker) systems where each client system may then “break-up” the order into smaller orders that are then submitted to one or more different exchange systems.

Each client system 100 could contain an order creator 101 that automatically (or manually via user input) creates order data message(s) 105-1-105-n. In one non-limiting example, the order data message(s) 105-1-105-n could contain information for carrying out an order request for an entity associated with system(s) 100. As can be seen in FIG. 1A, the order data message(s) 105-1-105-n (hereinafter referred to as order data message(s) 105) can be transmitted to different exchange systems 200-1-200-n. For example, a client system 100 can send order data message(s) 105 to the New York Stock Exchange® while also sending order data message(s) 105 to the Chicago Board of Trade®. Each order data message(s) 105 could contain an order related to a same and/or different tradeable instrument.

As mentioned above (and although not shown in FIG. 1A), a child system (e.g., a broker system) could receive a parent order(s) from a parent system (e.g., a hedge fund). In one non-limiting example, the child system may divide the parent order(s) into further individual orders that, when taken as a whole, comprise the entire parent order(s). Likewise, the child system may only receive a portion of the parent order(s) and parent system could send multiple parent order(s) messages to a variety of different child system(s). The child system could further comprise its own order creator (e.g., order creator 101) that is used to generate order data messages transmittable to an exchange system(s) 200-1-200-n (hereinafter referred to as exchange system(s) 200).

It should be appreciated that the system(s) 100 and 200-1-200-n employ a variety of communication circuitry, as well as processing circuitry that includes input/output devices, data transceivers (for transmission of digital and/or analog signals), one or more processors (e.g., a CPU), one or more storage devices (e.g., a memory), and/or one or more audio/visual components (e.g., sound interface, display). Such components are highlighted and discussed with respect to FIG. 7, below.

FIG. 1B shows a non-limiting example system where trade data is communicated from an exchange system to a client system and a data file is then communicated between the client system and a server system. It should be appreciated that certain surveillance systems (e.g., external systems 120, discussed below) generate web-based applications designed to assist parties in meeting certain compliance requirements. However, certain tradeable instruments may not be traded on an exchange accessible by these surveillance systems. Thus, data from these various sources may be collected (e.g., via server system(s) 220) and then used for conducting surveillance on the trade related data. As discussed further below, data file(s) 102 may include trading data in an “end-of-day” file indicating the trade data for a current data for one or more parties.

Using the example shown in FIG. 1A, when one or more order(s) 105 match at exchange system(s) 200 (e.g., via the matching engine 211), the exchange system(s) 200 can generate data reporting the trade to client system 100. For example, exchange system(s) 200 can generate one or more trade data message(s) 116-1-116-n indicating that an order has executed as a trade (i.e., matched). The trade data message(s) 116-1-116-n could be data messages between exchange system(s) 200 and client system(s) 100 containing different details related to trades of one or more orders. For example, the data message could include data elements indicating the type of instrument traded, the specific instrument traded, a trade price for the instrument, a volume traded for the instrument, identifiers related to the order, and/or flag data indicating whether the order is a parent order (or child order). These data elements are non-limiting and the technology described herein envisions any combination and/or number of different data elements that could be included in the data message.

Client system(s) 100 can receive and accumulate the trade data message(s) 116-1-116-n and store the same in a memory of system 100. In one non-limiting example, client system(s) 100 will store the data messages as data file(s) 102 in the memory of the system 100. The data file(s) 102 could contain one or more data files containing certain elements transmitted in the trade data message(s) 116-1-116-n. In one non-limiting example, client system(s) 100 may parse the data messages for extracting certain elements and such information may be stored in data file(s) 102.

Although not shown in FIG. 1B, the data collected and stored in data file(s) 102 may be transmitted to a parent system. In one non-limiting example, the data file(s) 102 transmitted to a parent system may be an “overnight order listing” (or an “end-of-day” trading file) containing all trade information related to orders placed by parent system with child system for a given day (or any other period of time). The data file(s) 102 may be a flat file transmitted to the parent system (or “picked up” by parent system at a specified period of time). In one non-limiting example, the data file(s) 102 may be a comma separated flat file having records containing individual elements associated with trade data as seen, for example, in FIG. 4 and discussed in further detail below. The parent system may receive the data file(s) 102 and store them in a memory of the parent system. It should be appreciated that the data file(s) 102 may be automatically uploaded to server system(s) 220 or the data file(s) may be placed on an FTP/SFTP server that the server system(s) 220 can “visit” to obtain the data file(s) 102.

Returning to the example shown in FIG. 1B, the data file(s) 102 may be transmitted from the system 100 to server system 220 where server system 220 can parse the data and store the same in a database 224 of the server system 220. For example, server system 220 may convert the data from data file(s) 102 to an internal format used by system 220 and/or system 120.

It should be appreciated that each data file(s) 102 may have information including, but not limited to, an exchange type, asset type, underlying information, and/or price associated with different orders/trades. Prior to being processed at the server system(s) 220, the data file(s) 102 may be processed through a symbol mapper 150. In one non-limiting example, the symbol mapper 150 will apply fuzzy mapping logic to the data file(s) 102 in order to determine the appropriate symbol associated with a given tradeable instrument. While shown as separate from system(s) 220 in FIG. 1B, it should be appreciated that the mapper 150 may be integrated (or external from) system(s) 220. It should be further appreciated that system(s) 220 may also process data file(s) 102 before submitting the information in data file(s) 102 to mapper 150.

The content of the data file(s) 102, as well as the processes for parsing the file(s) 102, applying fuzzy mapping logic, storing the parsed data in memory, and generating a user interface is discussed in further detail with respect to FIGS. 2-6C, below. It should also be appreciated that the server system(s) 220 may be a separate system from exchange system 200 or could alternatively be the same as exchange system 200.

### Description of FIG. 2

FIG. 2 shows a non-limiting example diagram of a system 200 wherein the framework for processing order data and generating a user interface can be implemented. As will be described below, one or more applications that implement the framework for processing order data and generating the user interface can be deployed in the system 200, and the various components in the system 200 (such as the client system(s) 100, server system(s) 220, and/or external system(s) 120) can perform different functions related to the deployed applications. In one non-limiting example, the external system(s) 120 may constitute a surveillance system for monitoring market data in order to, for example, spot fraudulent or illegal activity.

As will be discussed below, FIG. 2 shows primarily software modules (such as the software module 124) executing at the external system(s) 120, server system(s) 220, and the client system(s) 100; it should be understood that the software modules shown in FIG. 2 are stored in and executed by hardware components (such as processors and memories); details regarding example hardware components that may be used to execute these software modules are provided below with reference to FIG. 7, as well as in other places in this document.

One or more client system(s) 100 can be configured to produce one or more data file 102 containing data associated with orders generated by system(s) 100. The data file 102 could be an electronic data message and/or a data file formatted for processing by server system(s) 220. For example, data file 102 could be in the form of an XML file having different tags that are associated with data entries processed by system(s) 220. In another example embodiment, data file 102 could be a flat file having different entries separated by delimiters denoting different fields. In one example, the delimiters could be commas (e.g., a comma separated file). This example is non-limiting and the technology described herein envisions any type of delimiters for separating data elements in the data file 102. Elements comprising the data file 102 are shown, for example, in FIG. 4 and discussed in detail throughout this document.

It should be appreciated that client system(s) 100 may be any client system interacting directly or indirectly with server system(s) 220. For example, client system(s) 100 could be a parent system(s), child system(s), or any other client system directly or indirectly communicating with server system(s) 220. In one example, client system(s) 100 could be associated with a broker and the data file(s) 102 generated by client system(s) 100 could be an “end-of-day” trading file providing all trading details for the broker for that day (or any period of time).

Server system(s) 220 are configured to communicate with client system(s) 100 and external system(s) 120 (e.g., via network 130). It should be appreciated that the network 130 could comprise a network of interconnected computing devices, such as the Internet. The network 130 could also comprise a local area network (LAN) or could comprise a peer-to-peer connection between the different devices in the system. The server system(s) 220 could comprise any variety of server devices including, but not limited to, database servers, file servers, web servers, application servers, a server cluster (e.g., a cloud based computing environment), a standalone server, and/or any other portable or stationary computing device having server-based capabilities. It should be appreciated that the server system(s) 220 can be implemented using separately located hardware (e.g., remote hardware) or can be implemented using a same piece of hardware (e.g., within a single housed server device).

Server system(s) 220 can receive the data file(s) 102 from client system(s) 100 via network 130. Upon receiving data file(s) 102, the parsing module 221 of server system(s) 220 is configured to parse different elements in the data file(s) 102. In one example, the data file(s) 102 may be a comma separated data file where one or more commas separate the data elements in each data entry. Parsing module 221 is configured to search for the respective delimiter (e.g., a comma) and then extract individual data elements from the file for storage.

After (or before) parsing the data file(s) 102, server system(s) 220 may process the data elements in the data file(s) 102 using a symbol mapper 225. As will be explained in more detail below, the symbol mapper 225 may apply fuzzy mapping logic to the elements in the data file(s) 102 in order to determine an appropriate symbol for a tradeable instrument on a given exchange system. In one non-limiting example, symbol mapper 225 may apply the fuzzy mapping logic to generate a symbol associated with the tradeable instrument and then may modify data file(s) 102 to include the correct symbol for further parsing and storage. Alternatively, the symbol mapper 225 may generate a symbol and then store the elements along with the other parsed elements in the database 224 of the system(s) 220.

Once the file has been parsed and/or processed by fuzzy mapping logic, the system(s) 220 can store the parsed data in database 224. The database 224 may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system).

The server 220 can further include an application server 223 that can, for example, execute server-side (or “back end”) instructions for applications that run on the server system 200. In one non-limiting example, the application server 223 may generate data associated with a user interface that is displayable on a display connected to external system(s) 120. The server system(s) 220 may also contain a filter module 222 that is configured to filter data transmitted to external system(s) 120, particularly when generating a user interface for display. In one example, the filter module 222 may be configured to filter order data so that only order data associated with a parent order are transmitted to external system(s) 120.

The external system(s) 120 can include software components for performing processing related to applications deployed in the system. As a non-limiting example, the external system(s) 120 may have a client application 121 consisting of, at least, a rendering module 122, a networking module 123 and a software module 124. Of course, these modules are a non-limiting example, and the application 121 can comprise several more modules and/or different modules than those shown in FIG. 2. The external system(s) 120 could comprise any variety of client-based devices including, but not limited to, a personal computer (e.g., a desktop computer, a laptop computer), a thin client, a hybrid client, a rich client, a game console, a tablet, a personal digital assistant (PDA), a smartphone, a digital music player having web interface capabilities, and/or any other portable or stationary computing device.

The rendering module 122 in the external system(s) 120 can implement functionality for the graphical display and rendering of user interfaces. It can, for example, generate graphical data that corresponds to an image class that represents graphical images processed by the client application 121; this graphical data can, potentially after further modification/transformation by the operating system of the external system(s) 120, be displayed on a display of the system(s) 120. Alternatively or additionally, whenever it is described in this document that the external system(s) 120 renders/displays image data, the rendering/displaying module 122 may perform functionality related to the rendering/display of the image data.

The networking module 123 can implement a communication protocol, and be used to handle various data messages between the external system(s) 120 and, at least, the server system(s) 220. In one non-limiting example, the networking module 123 may carry out a socket connection by using a software connection class to initiate the socket connection between devices. Once the sockets are connected, networking module 123 may transfer data to/from the server 220.

The software module 124 can be used to execute various code loaded at the client application 121, and perform other functionality related to the software. The software module 124 may be, for example, a Java runtime engine or any other type of software module capable of executing computer instructions developed using the Java programming language. This example is of course non-limiting and the software module 124 may execute computer instructions developed using any variety of programming languages including, but not limited to, C, C++, C#, Python, JavaScript, or PHP. Alternatively or additionally, whenever it is described in this document that the external system(s) 120 performs functionality related to the software module, such functionality may be handled by the software module 124.

It should be appreciated that the components shown in FIG. 2 can be implemented within a single system. The components could also be incorporated in multiple systems and/or a distributed computing environment (e.g., a cloud computing environment). Thus, the system is not limited to a single component and can be incorporated into multiple components.

### Description of FIG. 3

FIG. 3 shows a non-limiting example communication process between devices within the system. The communication process shows example communication between at least one client system 100, server system 200, and external system 120. It should be appreciated that this communication process can be carried out, for example, using network 130. In one non-limiting example, the processes shown in FIG. 3 begin after the system 100 (shown in FIGS. 1A and 1B) has received the trade data messages 116 from exchange systems 200.

In the example shown in FIG. 3, the communication process begins when client system 100 accesses a memory storage at action 301 in order to retrieve the data file 102. For example, client 100 may have a pre-stored flat file in a memory storage associated with client 100. Alternatively, client 100 may run a query assembling all of the elements needed for the data file 102 in order to prepare the data file 102 for transmission. In one example, the data file 102 will represent all trading activity that has occurred for one or more entities associated with client 100 for a given day. The data file 102 could be an “end-of-day” trading file, as discussed with respect to data file 102 above.

Once the data file 102 is ready for transmission, client 100 can transmit the data file 102 to server 200 at action 302. In one example, client 100 can establish a network connection with server 200 and actively transmit the data file 102 to server 200. In another non-limiting example, client 100 may retrieve the data file 102 and then place the data file 102 into a file storage location that is accessible by server 200 for retrieval. That is, client 100 may put the data file 102 into a “folder” that is accessible by server 200 and server 200 will obtain the data file 102 once available (or at any time after the data file 102 is available). It should be appreciated that the steps carried out between client 100 and server 200 are non-limiting and the technology envisions a variety of methods in which the data file 102 can be transmitted to (and obtained by) server 200. For example, server 200 may actively request data file 102 from client 100.

Client 100 may also be programmed to prepare the data file 102 for pick-up by server 200 and store the data file 102 into a memory location serving as a temporary “pick-up” area for server 200. Server 200, at some point in time after the data file 102 is available, may then obtain the data file 102 from client 100 by accessing the memory location serving as the “pick-up” area for the file. The examples discussed above refer to a single data file 102, but it should be appreciated that the client 100 and server 200 may communicate a plurality of data files 102 between each other. It should further be appreciated that client 100 and server 200, instead of transferring a data file 102, may communicate the individual data contained within the data file 102 (e.g., during a real-time communication session between client 100 and server 200).

Upon receiving the data file 102, server 200 may, at action 303, acknowledge receipt of the data file 102 by sending a return message to client 100. In one non-limiting example, server 200 may send an acknowledgment of receipt message indicating that the data file 102 has been successfully received by server 200, or may issue a message indicating that transfer of the data file 102 has failed. In yet another non-limiting example, server 200 may analyze data file 102 to determine if data file 102 contains any data and/or is properly formatted. If data file 102 does not contain any data and/or is improperly formatted, server 200 may reject receipt of data file 102 and send a message to client 100 providing indication of the issue with the received data file 102. Alternatively, server 200 may store data file 102 but continue to issue a message to client 100 indicating the problems with data file 102.

At action 304, server 200 may parse the elements of the data file 102 in order to extract individual elements for storage and processing. In one example, the data file 102 will be a comma separated file in which the server 200 may be able to identify and parse individual elements from the data file 102. For example, the data file 102 may identify a type of security being traded, a price, and volume of the security. Each of these individual elements (e.g., type of security, price, volume) may be separated by a comma (or some other type of delimiter) in the data file 102 where server 200 can identify as being separate from each other and, based on a predetermined location of the element within each “record” of the data file 102, obtain the elements and store them in memory. For example, upon successfully parsing each record entry in the data file 102, the server 200 may store the associated elements into relevant portions of one or more tables of a database memory of server 200.

In one non-limiting example, one or more of the elements in the data file may correspond to a symbol associated with a tradable instrument. At step 304, after parsing the elements from the data file 102, the system may also apply fuzzy mapping logic using the elements in the date file 102 to determine the appropriate symbology for a tradeable instrument. The details associated with the fuzzy mapping logic are described in further detail with respect to FIGS. 5A-6C below.

At action 305, external system 120 may load a user interface for display on a display device operatively coupled to system 120. For example, system 120 may load an application that can generate a user interface for displaying information related to one or more trades associated with different entities that have conducted exchanges via server 200. In doing so, external system 120 may, at action 306, request data for populating and/or rendering the user interface. For example, the user interface may display data that shows different objects representing trades that were matched by server 200 along a graph representing a time of the trade along one axis and a value of the trade along another axis.

The data required to populate the display with these elements may be generated by server 200 at action 307. In one non-limiting example, the system 120 may have requested data related to all trades that occurred on a given day (or any other period of time) for one or more entities (e.g., brokers, individuals, hedge funds). The server 200 may then access a database to obtain the relevant information requested in the query from system 120 and then transmit such data to system 120 at action 308.

At action 309, external system 120 may generate/update the user interface being displayed using the data received from server 200 at action 308. In one non-limiting example, system 120 may generate/update the user interface to provide various information regarding trading activity.

At action 310, external system 120 may make subsequent requests (either automatically or via user manipulation) for data in updating and/or further generating additional displays related to the user interface. Although actions 301-310 are shown in FIG. 3 as occurring once, these actions 301-310 may, in various embodiments, be repeated a number of times.

Description of FIG. 4

FIG. 4 shows a non-limiting example data file 102 that is communicated between, at least, client 100 and system 200. In the example shown in FIG. 4, data file 102 will contain various data “records” where each individual element in the records are separated by a delimiter (e.g., a comma) This example is of course non-limiting and the technology described herein envisions any variety of delimiters that can be used to separate data elements including, but not limited to, colons, semi-colons, and/or tab delimiters. It should be appreciated that the data file 102 may not necessary be a flat file, and may instead be any other type of data file (e.g., XML file) for communicating the data elements. It should be appreciated that the elements shown in FIG. 4 are non-limiting and the system can support various “message” types including, but not limited to, a new order indicating entry of an order into an order book, a replace order indicating amendment of an order previously entered, a cancel order indicating deletion of an order previously entered, a fill trade indicating filing of an order previously entered or transaction of a trade without an order, an off-exchange trade indicating an Off Exchange Trade (e.g., floor trade), a replace trade indicating of modification of a trade previously transacted, and/or a cancel trade indicating removal of a trade previously transacted.

In the example shown in FIG. 4, the records in data file 102 may relate to one or more tradeable instruments (e.g., securities) that are traded/exchanged via system 200. Each record could thus contain individual data elements associated with different information related to the trade. For example, the record could contain an exchange identifier 401 identifying a specific exchange for tradeable instruments. In the example shown in FIG. 4, the exchange identifier 401 “IDEM” corresponds to an identifier for the Italian Derivatives Market.

Each record can be further associated with an order entry type 402 identifying the specific type of order for a particular transaction. For example, order entry type 402 could relate to a “New Order” indicative of a brand new order to buy or sell a particular tradeable instrument or a “Cancel Order” indicating that a specific order should be canceled. These values are of course non-limiting and the technology envisions a variety of values that could be represented as an element for order entry type 402 including, at least, an “Amended” order, a “Fill” order, and a “Replace Order,” amongst others.

The records in the data file 102 may also contain a transaction time 403. The transaction time 403 may include an element that contains both a date and time a transaction associated with order entry type 402 was initiated. The transaction time 403 for data record (1) shown in FIG. 4 includes both a date element of “2017-09-14” (Sep. 14, 2017) and a time element of “09:00:11.000” (9:00.11 AM). Of course, this example is non-limiting and the technology described herein envisions each record including further (or less) details associated with the date and/or time of a particular transaction.

Each record can further contain a message date 404 indicative of a specific date the order message was created. The example data file 102 shown in FIG. 4 reflects an end-of-day trading file and thus the example elements shown correspond to transactions occurring for a single day. Thus, each record in the example shown in FIG. 4 has a message date 404 of “14/09/2017” (Sep. 14, 2017).

Each record in the data file 102 may also contain a message identifier 405. The message identifier 405 may be a string containing text with a combination of alphanumeric characters that uniquely identify a specific data message. It should be appreciated that some message identifiers 405 may be different or the same as other message identifiers 405 in various data records. For example, and as can be seen in FIG. 4, record (1) contains a message identifier 405 of “UK50:170914:188147” where record (2) is “UK50:170914:188149.” However, records (2) and (3) both contain identifier 405 of “UK50:170914:188149.” Records with duplicate identifiers could be indicative of the record having different order entry type 402. For example, record (2) reflects a “New Order” for “UK50:170914:188149” where record (3) is indicative of a “Replace Order” for the same order message.

Each record in the data file 102 may also contain an instrument indicator 406 as well as an instrument type 407. In the example of FIG. 4, data record (1) shows an instrument indicator 406 of “MINI7I” and instrument type 407 of a “Derivative.” Each record can also include an asset class 408 as well as a buy/sell indicator 409. In the example of FIG. 4, data record (1) contains a “Future” asset class with a “Sell” indicator indicative of the data message being placed for a sell order. It should be appreciated that these examples are non-limiting and the technology envisions any variety of instrument, instrument type, asset class, and/or indication other than buy or sell (e.g., trade).

The records in the data file 102 may further include a price 410 and volume 411 indicative of the price and number of units to be bought/sold for a given instrument. The derivative associated with record (1) has a sell price of “22205” and a volume of “6.” It should be appreciated that the value in price 410 may omit decimal places in the string containing the price and thus the first two characters from the right may be reflective of the “cents” while the characters following the first two from the right may be reflective of the “dollars” of the order. Thus, in record (1) the order may be to sell 6 shares of the derivative for $222.05.

The data records may also include a Committee on Uniform Securities Identification Procedures (CUSIP) number 412 as well an instrument long name 413 and maturity date 414 for a particular instrument. For example, record (1) in FIG. 4 contains a CUSIP number of “2MP0000017I” with an instrument long name “Milan Stock Exchange MINI FTSE MIB Index Future” and maturity date of Sep. 15, 2017. The data records can further include a currency type 415, a maturity type 416, and an effective date 417. In the example of FIG. 1, record (1) contains a currency type of “EUR” indicating the currency is the Euro with a standard maturity type and an effective date of Mar. 20, 2017.

It should be appreciated that the data elements discussed in this example are non-limiting and the technology described herein envisions any variety of additional data elements providing further information associated with each data record. For example, the data elements included in data file 102 can further include, but are not limited to, an execution time, a link message identifier, a parent order identifier, an account identifier, an account type, a trader identifier, a parent flag, a book code, a book name, a counterparty firm, a counterparty account, a sales person identifier, an FX buy currency, an FX buy value, an FX sell currency, a transaction source, a transaction version, a deal identifier, a swap leg type (e.g., fixed or floating), a swap leg currency, a swap leg price, a swap leg amount, a swap leg instrument, a swap leg indicator, a swap start date, a unique swap identifier, a unique transaction identifier, a legal identity identifier, a desk identifier, an ISIN identifier, a SEDOL identifier, a strike price, a put/call indicator, a term (e.g., contract term) identifier, a settlement type, a settlement currency, and a settlement date, among others.

### Description of FIGS. 5A-D

FIGS. 5A-C show non-limiting example methods carried out by components in the system. FIG. 5D shows a specific example process carried out by, for example, symbol mapper 225 to determine a symbol using the symbol mapping logic.

FIG. 5A specifically shows a process that can be carried out, for example, by server 200 for processing the data file 102 received from client 100. At action 501, server 200 may obtain data file 102 from client 100 containing the information associated with one or more trades, and shown in further detail with respect to FIG. 4. Although the example described herein depicts the data file 102 as a comma separated flat file, the data file 102 is not limited to such an embodiment and the data records could be transmitted using a variety of methods. For example, instead of a comma separated flat file, data file 102 may be an XML file having different elements associated with an individual trade identified by different “tags” in the XML file. The server 200 could identify the individual elements based on the “tag” identifiers and then extract the information associated with each element following the “tag” identifier.

At action 502, server 200 may load and pre-process the data file 102. In one non-limiting example, server 200 may load and analyze the data file 102 to ensure that the data file 102 is ready for processing. For example, the server 200 may confirm the data file 102 includes content having the records as discussed with respect to FIG. 4. Server 200 may also determine if the format of the data file 102 is proper for pre-processing. For example, server 200 may confirm that the data file 102 is a comma separated data file where each individual element in the records are separated by a comma After determining that the data file 102 is properly formatted, the server 200 can attempt to parse the data file 102 and extract one or more elements from the file 102 for analysis.

At action 503, the server 200 may apply the fuzzy mapping logic to one or more elements extracted from the data file. In one non-limiting example, after the server 200 has parsed elements from the data file 102, the server 200 can collect the underlying information elements, the asset type, and the market in which the trade was conducted, and may apply them to symbol mapper 225. The details of the processes carried out by the symbol mapper 225 are discussed in further detail with respect to FIGS. 5B and 5C, below.

At action 504, the server 200 may modify one or more data elements extracted from data file 102. In one non-limiting example, the server 200 may convert an element that corresponds to a symbol for a tradeable instrument into a new symbol. For example, the symbol mapper 225 may determine that the symbol associated with a tradeable instrument should be altered to more accurately reflect the symbology for the instrument on a given exchange. Thus, the server 200 may modify one or more elements extracted from the data file 102 at action 504 by “re-writing” the element associated with the symbol. In one non-limiting example, the server 200 may modify the data element associated with the symbol in the data file 102 and then process and store the elements of data file 102 in a database of the system (at action 505). In another non-limiting example, the server 200 may temporarily store the data elements in a memory and then modify the data element associated with the symbol in the memory.

After modifying the elements extracted from file 102, the server 200 at action 505 can store the individual elements in one or more tables of a database stored in a memory of server 200. In one non-limiting example, server 200 may have a database containing one or more tables storing each piece of information related to individual trade(s) that is extracted from the records provided in data file 102 as shown, for example, with respect to FIG. 4. The tables could contain additional information not extracted from the data file 102 (e.g., a unique identifier).

FIG. 5B shows a non-limiting example flowchart of the processes carried out by, for example, server 200 when applying fuzzy mapping logic to elements extracted from file 102. In the example of FIG. 5B, the processes may be carried out substantially by server 200 when applying the fuzzy mapping logic to the elements in data file 102. The example shown in FIG. 5B also depicts a situation where a given market may be known when applying the fuzzy mapping logic.

At action 506, the server 200 may obtain a list of formulas that are used to map the underlying elements to one or more candidate symbols. The list may be filtered based on an identified exchange and/or instrument type. For example, if an instrument type for an underlying asset is an “option” and the asset is being traded on the New York Stock Exchange®, then the list of formulas that will be used in the mapping process will only be the ones associated with “options” traded on the New York Stock Exchange®. It should be appreciated that action 506 may be completed in one single action by “looking up” the list of formulas using the identified exchange and instrument type as inputs. However, action 506 may also be divided into multiple steps where the formulas may be accessed first by the identified exchange and then the instrument type. Likewise, the formulas may be accessed first by the instrument type and then the identified exchange.

At action 507, the system may determine the elements of underlying information that can be supplied to the symbol mapper 225. For example, the data message associated with the asset may contain other elements such as an underlying instrument identifier, an instrument type, an International Securities Identification Number (ISIN), a CUSIP number, a Stock Exchange Daily Official List (SEDOL) identifier, a maturity date, a strike price, a “put” or “call” flag/identifier, a term, a currency type, a settlement date, a settlement type, a session identifier, and/or a price.

At action 508, the server 200 may apply one or more of the elements of underlying information to symbol mapper 225 to generate one or more candidate symbols. For example, the symbol mapper 225 may determine a candidate symbol if the underlying elements contain at least an underlying instrument identifier, a maturity year (that can be determined from, for example, a maturity date), a strike price, a maturity month, and a “put” or “call” identification. Other elements of underlying information may also be used to determine other candidate symbols.

Once one or more candidate symbols are selected, the server 200, at action 509, may compare the candidate symbols to those traded on the day. In one non-limiting example, the candidate symbols may be compared to those traded on the known exchange and/or instrument type. For example, the candidate symbols may be compared to those traded on a U.S. Options market to determine if the candidate matches one traded on that market.

At action 510, the server 200 will determine if a match is found based on the comparison carried out at action 509. In one non-limiting example, the candidate symbol may not match any symbol traded on that day for the particular exchange. In another non-limiting example, the candidate symbol may match more than one symbol traded on that day for the particular exchange. In both of these instances, server 200 may then proceed to action 513 and determine that no symbol should be selected from the candidate symbols.

In another non-limiting example, the server 200 may determine that one candidate matches a symbol traded on that day for the particular exchange. In this case, the server 200 could determine that a match for the symbol is found and proceed to action 512 (not shown in FIG. 5B). In another example embodiment, and as can be seen in FIG. 5B, the server 200 could then optionally determine if the price associated with the selected symbol (e.g., the price of a particular contract) is within a high/low price range of the same symbol on the exchange at action 511. If the price associated with the symbol is not within the price range (e.g., the price is below the “low” range or above the “high” range), then the server 200 may proceed to action 513 and determine that no symbol should be selected. However, if the price is within the price range, the server 200 can select the candidate symbol, at action 512, as the appropriate symbol associated with the exchange. It should be appreciated that, in instances where multiple matches are found (e.g., at action 510), the server 200 may determine if one of the matches is within the particular price range (e.g., at action 511) in order to select the candidate symbol at action 512. That is, if multiple matches are found, and one match is within a particular price range, then server 200 may select the symbol within the price range at action 512.

FIG. 5C shows a non-limiting example flowchart for processes carried out, for example, by server 200 when an exchange is not known in the symbol mapping process. FIG. 5C could pertain to a case, for example, where a buying party for a particular order sends a “parent order” to different agents (e.g., brokers) where each broker can then attempt to fill the “parent order” using multiple different exchanges. For example, a hedge firm may place an order with one or more brokers to purchase 1000 shares of a particular tradeable instrument, and the one or more brokers may use multiple exchanges (e.g., NASDAQ®, New York Stock Exchange®) to fill the order. The firm submitting the “parent order” may not know exactly what exchange was used to fill different elements of the order, and thus the processes shown in FIG. 5C detail how the system applies the fuzzy mapping logic in this situation.

In particular, the process of FIG. 5C begins by first determining the asset type at action 514. For example, the system can determine if the asset type is an equity, stock, bond, security, or any other type of asset type. After determining the asset type the system may then collect any provided underlying information at action 515. For example, the data message associated with the asset may contain other elements such as an underlying instrument identification, an instrument type, an International Securities Identification Number (ISIN), a CUSIP number, a Stock Exchange Daily Official List (SEDOL) identifier, a maturity date, a strike price, a “put” or “call” flag/identifier, a term, a currency type, a settlement data, a settlement type, a session identifier, and/or a price.

At action 516, the system can generate candidate symbols based on the collected underlying information. For example, if the asset type is a Future and only underlying and maturity date are available from the underlying information, the system may filter several formulas for determining the candidate symbol and a list of candidate symbols can then be generated.

These symbols can then be compared to symbols for the markets being processed at action 517. At action 518, the system can, for every individual candidate symbol, attempt to match the symbol to the list of symbols for a marketing that is being processed. For example, if the system is analyzing symbols for the New York Stock Exchange®, the system can compare the candidate symbols to the list of instruments traded on the particular exchange to determine if there is a match.

Once one or more matches have been determined at action 518, the system can, at action 519, determine if the trade price for the particular symbol was within a given price range for that symbol on the particular exchange. For example, the trade price may be compared to a high and low for the same symbol on the exchange to determine if it was within the particular range. If a symbol is within the range and no other candidate symbols result in a match, then, at action 520, the system selects the candidate symbol as the appropriate symbol for that exchange. If no match is found, the system proceeds to action 521 in which no symbol is selected.

It should be appreciated that, at action 520, no match may be determined. For example, the candidate symbol may not match any symbol traded on that day for the particular exchange. In another non-limiting example, the candidate symbol may match more than one symbol traded on that day for the particular exchange. In both of these instances, server 200 may then proceed to action 521 and determine that no symbol should be selected from the candidate. Alternatively, in the case of multiple matches, the system may proceed to action 519 in which the price will be compared to determine if it falls within the given range, as discussed above. If one match exists after a comparison of the price range at action 519, the system may then proceed to action 520 to select the matched candidate symbol.

It should be understood that, although actions 501-505, 506-513, and 514-521 are described above as separate actions with a given order, this is done for ease of description. It should be understood that, in various embodiments, the above-mentioned actions may be performed in various orders; alternatively or additionally, portions of the above-described actions 501-505, 506-513, and 514-521 may be interleaved and/or performed concurrently with portions of the other actions 501-505, 506-513, and 514-521.

FIG. 5D shows a specific example method carried out by, for example, symbol mapper 225 to determine a symbol using the symbol mapping logic. The example shown in FIG. 5D depicts one example of the logic applied to a data message containing information for a trade that includes, at least, an asset type and underlying information. It should be appreciated that the data message may also include price information and an exchange type associated with the trade.

The processes carried out in FIG. 5D in one non-limiting example can be a specific example of the processes carried out and discussed above with respect to FIGS. 5A-C, and throughout the specification. In the example shown in FIG. 5D, it is assumed that the information from the data message has been received, processed, and successfully extracted and thus the steps shown in FIG. 5D depict the logic applied to such information.

The process begins at action 522 where the system loads different formulas associated with different symbologies across different asset types. For example, the system could load formulas for determining a variety of symbols across futures, options, etc. Each formula could comprise one or more elements for determining different parts of the symbol. For example, the formula could utilize a maturity year when forming the symbol code, where another formula could use a session identifier.

At action 523, the system identifies the asset type associated with the data message. In the example shown in FIG. 5D, the asset type is a future and thus the system, at action 524, filters the list of formulas for only those associated with futures. The system in this example produces three resulting formulas associated with futures thereby narrowing the number of formulas the system will apply the data elements to when determining candidate symbols.

At action 525, the system can apply the elements of additional information extracted from the data message to the list of remaining formulas. If one or more elements required by a particular formula are not available from the elements extracted from the data message, the system will not apply the formula and will thus only use the formulas in which each element of the formula is available.

The example of FIG. 5D indicates that elements such as the underlying instrument, maturity year, and maturity month are known and extracted from the data message. Specifically, the underlying instrument is “GOLD” with an underlying maturity year of “2017” and maturity month of “Jan” (i.e., January).

At action 526 the system will apply these known elements to formulas requiring these three elements for determining the symbol. In this example, and as can be seen at action 524, the available information is relevant to two of the three listed formulas. More specifically, as the session identifier is not a piece of available information, the formula requiring “Underlying+Session+MaturityYear+MaturityMonth” is not used and the other two remaining formulas are used instead.

As such, at action 526 two candidate symbols are used by applying the elements to the two formulas. More specifically, the symbols can be generated by combining the elements of the available information to produce the candidate symbol. For example, as “GOLD,” “2017,” and “Jan” are known elements for the underlying symbol, maturity year, and maturity month, the formula related to “Underlying+MaturityYear+MaturityMonth” generates a symbol that combines “Gold,” a two-character maturity year of “17” (i.e., from 2017), and a two-character maturity month of “01” resulting in the symbol “GOLD1701.” Likewise, the formula related to “Underlying+MaturityMonthCode+MaturityYear” generates a candidate symbol that combines “Gold,” a single character maturity month code of “Z,” and a two-character maturity year of “17” resulting in the symbol “GOLDZ17.”

Knowing at least these two candidate symbols, the system, at action 527, can compare the codes to known symbols for a particular exchange. For example, if the associated data message relates to a trade/order on the Chicago Mercantile Exchange® (as is the case in the example of FIG. 5D), then the system can compare the candidate codes to known symbols used for that exchange. In this example, the system finds one match with symbol “GOLDZ17” and thus there is a high likelihood that the candidate symbol is the correct symbol used on this particular exchange. It should be appreciated that no candidate may be selected if the system at action 527 produces no match (or more than one match). In this case, the symbol could be manually modified to match the appropriate symbology for the exchange.

In the case of one or more matches, the system, at action 528, could also compare the price associated with the symbol to the high and low prices on the market. If the price is within the high and low range, then the system can confirm (at action 529) that the selected symbol is the proper symbol for the exchange (i.e., symbol “GOLDZ17”). It should be appreciated that, in one non-limiting example, the system may optionally skip action 528 and determine the candidate symbol based on all of the previous steps without comparing the price to high and low ranges on the market.

### Description of FIGS. 6A and 6B

FIGS. 6A and 6B show a non-limiting example diagram of the elements comprising a data message and listing of candidate formulas, respectively. FIG. 6C shows an example data file containing a list of instruments listed on a particular market. In the example shown in FIGS. 6A and 6B, the data elements available in the data message are applied to one or more candidate formulas to generate one or more candidate symbols. In the example shown in FIG. 6C, the candidate symbols that are output are then compared to the list of instruments listed on the market to determine a match for a particular symbol.

FIG. 6A shows an example TRADE data message 600 containing elements associated with a trade for a tradeable instrument. The data message 600 could contain one or more fields where each field may be populated with information associated with the field. In the example shown in FIG. 6A, the data message contains field UnderlyingSecurity 601 associated with the underlying security being traded, and AssetType 602 associated with the type of asset being traded.

The data message 600 may also include an International Securities Identification Number ISIN 603, a Committee on Uniform Security Identification procedures identifier CUSIP 604, and a Stock Exchange Daily Office List identifier SEDOL 605. The data message 600 may also include a MaturityDate 606 for a date that the given instrument will mature and a StrikePrice 607 indicating a price for which the instrument may be exercised.

The data message 600 may further include a flag for whether the instrument is a “Put” or “Call” via PutOrCall 608 thus identifying whether the owner or holder has the right to sell or buy shares of the instrument, respectively. The data message 600 may also include Term 609 indicative of a duration or term associated with the instrument for this particular trade. The message 600 may further include Currency 610 which can be used to identify the specific currency associated with the tradeable instrument (e.g., U.S. dollars, Japanese yen, Euro).

The data message 600 may contain further information including a SettlementDate 611 and SettlementType 612 associated with a date and type in which the instrument is delivered. In one example, the SettlementType 612 may include “traditional” physical settlement (e.g., payment by paper check) or could include electronic settlement. The data message 600 may further include a session identifier Session 613 and Price 614 indicative of a session and price associated with the tradeable instrument.

In the example of FIG. 6A, one or more elements in the data message may not be available as the pieces of information associated with a respective field. For example, items such as CUSIP 604 and Term 609 may not be included as available elements in the data message 600 (i.e., the items of information associated with those fields returns an empty or “NULL” value). Likewise, certain items of information will be available that the system can utilize in determining candidate symbols.

In the example of FIG. 6A, UnderlyingSecurity 601, AssetType 602, ISIN 603, MaturityDate 606, StrikePrice 607, PutOrCall 608, Currency 610, and Price 614 are items of information available from message 600. In this example, the data message 600 indicates that the underlying instrument is “Gold” options having a price of $10.20 U.S. dollars. The instrument also has an associated ISIN “02079K107” and is flagged as a “Put” option with a strike price of $1,092.50 and maturity date of Jul. 21, 2017. As described throughout this document, these items of information may be utilized with respect to one or more formulas when generating candidate symbols.

FIG. 6B thus shows a non-limiting example of selected formulas 650 in which the items of available information from FIG. 6A may be applied. In one example, selected formulas 650 may be a data structure having one or more columns associated with different fields of available information where at least one column may constitute a candidate symbol. For example, formulas 650 may contain fields Info1 651-Info6 656 indicative of one or more elements of information used to determine a candidate formula where field Mapped Symbol 660 may be indicative of a mapped candidate symbol (produced as a result of the elements used in the formula).

Each row in the data structure could then contain individual items associated with each formula. That is, each of fields Info1 651-Info6 656 could correspond to different elements making up the respective formula in determining a candidate symbol. As discussed above, one of the first steps of the fuzzy symbol mapping logic may entail identifying an exchange and/or instrument type to isolate certain formulas used for a particular asset type. In the example shown in FIGS. 6A and 6B, an exchange is not provided but the asset type (i.e., options) is known so the “options” formulas are acquired from the database 224. The example shown in FIG. 6B thus lists the “options” formulas resulting from this example query.

Using the available information identified in FIG. 6A, the system can attempt to apply the known elements to different formulas. In the example of FIG. 6B, as Term 609 and Session 613 were not provided in data message 600, the formulas in the first two rows are not used. However, the formulas in each of the last three rows contain elements which were provided in the example data message 600 of FIG. 6A. More specifically, the data message shown in FIG. 6A includes, at least, the underlying instrument, maturity date (in which each of a maturity day, month, and year can be deduced), strike price, and a put or call indication. Thus the system can apply those elements to the formula to produce a candidate data message.

It should be appreciated that each element may identify a character amount indication indicative of the number of characters the element will include. For example, an element “2 Char MaturityYear” indicates that the information associated with MaturityDate 606 will be used and represented by the year as two characters (e.g., a year of “2017” provided in MaturityDate 606 will be represented as “17”).

Using the information in fields Info1 651-Info6 656 for row three, the formula will apply information provided in MaturityDate 606, UnderlyingSecurity 601, StrikePrice 607, and PutOrCall 608. More specifically, the mapper will extract a two character year value from MaturityDate 606 for field Info1 651 (“17”), extract the information for UnderlyingSecurity 601 (“GOLD”), extract a six character strike price from StrikePrice 607 (“1092.50”), extract a single character maturity month code from MaturityDate 606 (“7”), and extract a single character identifier from PutOrCall 608 (“P”). The resultant elements may be directly concatenated (or concatenated with predefined spacing elements, such as a hyphen) to generate the candidate symbol “17GOLD1092.507P.” Using similar methodology, the other two rows can determine candidate symbols “P_GOLD_17Z” and “GOLD170721P01092500.”

With the candidate symbols, the system can compare them against the list of all symbols traded that day on the market in question. In the example of FIGS. 6A and 6B, is a specific exchange is not known, the system can compare them to the list of all symbols traded on the U.S. Options market to determine a match. For purposes of example and explanation, the system may determine that only symbol “GOLD170721P01092500” matches and is thus the likely symbol for the U.S. Options market for this given security. In order to ensure that the selected candidate symbol is the correct symbol, the contract price Price 614 of $10.20 may be compared to the high/low price range of the same symbol on the exchange. In this example, the high range may be $10.90 where the low range may be $9.80 and thus, as the $10.20 falls between this range (i.e., lower than the high range but higher than the low range), the system confirms that symbol “GOLD170721P01092500” is the correctly identified symbol.

FIG. 6C shows a non-limiting data file 670 including several elements that include, among others, one or more instruments traded on a particular exchange. The data file 670 shown in FIG. 6C may be extracted from a database of an exchange and may contain elements separated by one or more delimiters (e.g., comma, semicolon, tab). The data elements could include information associated with instruments traded on an exchange including, at least, a symbol used for a particular instrument on the exchange.

In one non-limiting example, the data file 670 could include a trade/transaction date 671. The trade/transaction date 671 could be a date and/or time associated with when a transaction for a particular instrument occurred on a given exchange. In the example shown in FIG. 6C, the trade/transaction date 671 reflects “20170914” (Sep. 14, 2017). It should be appreciated that the trade/transaction date 671 for each record may be the same or different in each data file 670. Moreover, the trade/transaction date 671 may be the same for each record in the data file 670 because the data file 670 could reflect only trading activity for a specific day.

The data file 670 could further include a trading symbol 672 indicative of a symbol associated with a tradeable instrument traded on the given exchange. The trading symbol 672 may be represented with a collection of numbers and/or characters that are used to identify a full name of a traded instrument. For example, an exchange may list a symbol for Nasdaq® as “NASQ.” In the example shown in FIG. 6C, the trading symbol 672 for the record is reflected as “pDIW00.” The system may use this symbol to compare to the candidate symbols to determine if there is a match, as discussed with respect to FIGS. 5A-D and throughout the specification.

The data file 670 may further include a currency identifier 673 identifying the currency for which the instrument is traded on this exchange. In the example shown in FIG. 6C, the currency identifier 673 is “EUR” reflective of the instrument being traded using the Euro currency. The data file 670 may also include an ISIN 674 depicting the International Securities Identification Number for a particular instrument. The ISIN 674 for record (1) shown in FIG. 6C corresponds to “IT0013523920.”

The data file 670 may also include an asset type 675 indicating the specific asset that is traded on the exchange. In the example shown in FIG. 6C, the asset type 675 corresponds to “GLE December 2017 Future” indicating that the instrument is a “Future.” The data file 670 may also include an instrument identifier 676 provided a specific identifier for a given instrument. The instrument identifier 676 may also include one or more elements included in the trading symbol 672. For example, the record shown in FIG. 6C has an instrument identifier 676 of “IW00” which includes some of the elements of symbol 672 which corresponds to “pDIW00.” It should be appreciated that the example shown in FIG. 6C is non-limiting and the technology described herein envisions any variety of different elements that could be included in the data file 670.

### Description of FIG. 7

FIG. 7 shows a non-limiting example block diagram of a hardware architecture for the system 1260. In the example shown in FIG. 7, the client device 1210 communicates with a server system 1200 via a network 1240. The network 1240 could comprise a network of interconnected computing devices, such as the internet. The network 1240 could also comprise a local area network (LAN) or could comprise a peer-to-peer connection between the client device 1210 and the server system 1200. As will be described below, the hardware elements shown in FIG. 7 could be used to implement the various software components and actions shown and described above as being included in and/or executed at the client device 1210 and server system 1200.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1222. As will explained below, these elements (e.g., the processors 1212, memory devices 1214, network interface devices 1216, display interfaces 1218, user input adapters 1220, display device 1222) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1222, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 7) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc. . . .

In some embodiments, the display device 1222 may be a Liquid Crystal Display (LCD) display, Light Emitting Diode (LED) display, or other type of display device. In embodiments where the display device 1222 is a component of the client device 1210 (e.g., the computing device and the display device are included in a unified housing), the display device 1222 may be a touchscreen display or non-touchscreen display. In embodiments where the display device 1222 is connected to the client device 1210 (e.g., is external to the client device 1210 and communicates with the client device 1210 via a wire and/or via wireless communication technology), the display device 1222 is, for example, an external monitor, projector, television, display screen, etc. . . .

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1200 also comprises various hardware components used to implement the software elements for server system 200 of FIG. 2. In some embodiments, the server system 1200 (which may also be referred to as “server device” herein) includes one or more of the following: one or more processors 1202; one or more memory devices 1204; and one or more network interface devices 1206. As will explained below, these elements (e.g., the processors 1202, memory devices 1204, network interface devices 1206) are hardware devices (for example, electronic circuits or combinations of circuits) that are configured to perform various different functions for the server system 1200.

In some embodiments, each or any of the processors 1202 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1202 uses an instruction set architecture such as x86 or Advanced RISC Machine (ARM).

In some embodiments, each or any of the memory devices 1204 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1202). Memory devices 1204 are examples of non-volatile computer-readable storage media.

In some embodiments, each or any of the network interface devices 1206 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1200 includes one, or two, or three, four, or more of each or any of the above-mentioned elements (e.g., the processors 1202, memory devices 1204, network interface devices 1206). Alternatively or additionally, in some embodiments, the server system 1200 includes one or more of: a processing system that includes the processors 1202; a memory or storage system that includes the memory devices 1204; and a network interface system that includes the network interface devices 1206.

The server system 1200 may be arranged, in various embodiments, in many different ways. As just one example, the server system 1200 may be arranged such that the processors 1202 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1200 may be arranged such that: the processors 1202 include two, three, four, five, or more multi-core processors; the network interface devices 1206 include a first network interface device that implements Ethernet and a second network interface device that implements WiFi and/or Bluetooth; and the memory devices 1204 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device 210 or the server system 200, each of which will be referred to individually for clarity as a “component” for the remainder of this paragraph, are implemented using an example of the client device 1210 or the server system 1200 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1200 (i.e., the one or more processors 1202, one or more memory devices 1204, one or more network interface devices 1206), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1200; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1200; (d) alternatively or additionally, in some embodiments, the respective memory devices store instructions that, when executed by the respective processors, cause the processors to perform, in conjunction with, as appropriate, the other elements in and/or connected to the client device 1210 or server system 1200, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein allows for efficient storage and processing of order data and improves the system's ability to display information and interact with a user. In particular, the system can process large volumes of order data elements and efficiently store the same in a database managed by the system so that the data can be used to generate the user interface. In doing so, the system efficiently stores, organizes, and manages large volumes of data by breaking the data down into understandable components that are used in fast and efficient generation of a display presenting the data.

The technology described herein also allows for efficient processing of data messages that improves the overall communication ability of the system. More specifically, the technology extracts certain elements from a trade data message and compares the elements to one or more formulas. The formulas may be filtered based on an asset type and/or an exchange. Based on the formulas and the extracted elements, the system can select one or more candidate symbols. With the candidate symbols generated, the system can compare them to known symbols on a particular exchange to identify the correct symbol. In doing so, the symbol for the tradeable instrument will be properly identified thus preventing any processing errors by the system and eliminating redundant (or corrected) data messages being sent to the system. By reducing processing errors and eliminating redundant data messages being sent to the system, the system improves the data communication latency between the system and devices communicating with the system. Moreover, the techniques described above ensure more accurate identification of the instruments involved in various trades thus reducing the need for human intervention to correct data records stored in the system.

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although a number of references are made in this document to web applications, it should be understood that the features described herein may also be used, in various embodiments, in the context of other types of applications such as applications that are deployed/installed as binaries on client systems.

Although process steps, algorithms or the like, including without limitation with reference to FIGS. 1-7, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A system configured to apply fuzzy symbol mapping logic to trade data in order to predict a symbol from a collection of symbol data, comprising:
a transceiver;
a processor; and
a memory configured to store computer readable instructions that, when executed by the processor, cause the system to:
receive a trade data message indicative of one or more trades processed for a tradeable instrument;
parse the trade data message to extract one or more elements associated with the trade for the tradeable instrument;
access a database stored in the memory to obtain a list of formulas for generating one or more symbols;
filter the list of formulas based on an asset type to generate a subset list of formulas;
apply the one or more extracted elements to the subset list of formulas and generate one or more candidate symbols;
compare the one or more candidate symbols to a list of symbols stored in the database, wherein the list of symbols is associated with an exchange type; and
attempt to match a candidate symbol based on the comparison to generate a selected symbol.

2. The system of claim 1, wherein the one or more elements extracted from the trade data message include underlying information elements associated with the trade, the underlying information elements applied to the subset list of formulas.

3. The system of claim 1, wherein the system is further caused to modify the trade data message by updating the trade data message with the selected symbol.

4. The system of claim 1, wherein each formula in the list of formulas is associated with a respective asset type.

5. The system of claim 1, wherein the system is further caused to filter the one or more candidate symbols based on a price range associated with the trade.

6. The system of claim 5, wherein if a selected symbol is outside of the price range associated with the trade, the system determines that a match has failed.

7. The system of claim 1, wherein if two or more candidate symbols match respective symbols in the list of symbols, the system determines that a match has failed.

8. The system of claim 1, wherein the trade data message contains, at least, an identifier of an exchange, an asset type, and underlying information elements.

9. The system of claim 8, wherein the underlying information elements include, at least, an underlying instrument, a maturity year, a maturity month, and/or a maturity month code.

10. A method for applying fuzzy symbol mapping logic to trade data to predict a symbol, comprising:
at an information processing system having at least one processor and a memory:
receiving a trade data message indicative of one or more trades processed for a tradeable instrument;
parsing the trade data message to extract one or more elements associated with the trade for the tradeable instrument;
accessing a database stored in the memory to obtain a list of formulas for generating one or more candidate symbols based on, at least, a type of tradeable instrument;
applying the one or more extracted elements to the list of formulas to generate one or more candidate symbols;
comparing the one or more candidate symbols to a list of symbols stored in the database; and
attempting to match a candidate symbol based on the comparison to generate a selected symbol.

11. The method of claim 10, wherein the list of symbols is associated with an exchange type.

12. The method of claim 10, the one or more elements extracted from the trade data message include underlying information elements associated with the trade, the underlying information elements applied to the subset list of formulas.

13. The method of claim 10, further comprising filtering the one or more candidate symbols based on a price range associated with the trade.

14. The method of claim 13, wherein if a selected symbol is outside of the price range associated with the trade, the information processing system determines that a match has failed.

15. The method of claim 10, wherein if two or more candidate symbols match respective symbols in the list of symbols, the information processing system determines that a match has failed.

16. A server system, comprising:
a transceiver;
a processor; and
a memory configured to store computer readable instructions that, when executed by the processor, cause the server system to:
receive a trade data message, from one or more terminal devices, including data associated with one or more trades processed for a tradeable instrument;
extract one or more elements from the trade data message to determine an exchange and an asset type;
access a data to obtain one or more formulas using the determined exchange and asset type, wherein the one or more formulas used to generate one or more symbols;
apply additional information from the extracted one or more elements to the one or more formulas to generate a list of candidate symbols; and
attempt to match a candidate symbol from the list of candidate symbols to generate a selected symbol.

17. The server system of claim 16, where the server system further caused to:
filter the list of formulas based on the determined asset type to generate a subset list of formulas;
apply the additional information to the subset list of formulas to generate the list of candidate symbols; and
compare the candidate symbols to a list of symbols stored in the database.

18. The server system of claim 17, wherein the server system further caused to attempt to match the candidate symbol based on the comparison to generate the selected symbol.

19. The server system of claim 16, wherein the system is further caused to filter the one or more candidate symbols based on a price range associated with the trade.

20. The server system of claim 19, wherein if a selected symbol is outside of the price range associated with the trade, the system determines that a match has failed.
